(19) United States
(12) Patent Application Publication
(10) Pub. No.: US 2004/0100451 A1
(43) Pub. Date: May 27, 2004

(54) Electronic apparatus and operation mode switching method

(76) Inventor: Kazuteru Okada, Mitaka-shi (JP)

Correspondence Address: Finnegan, Henderson, Farabow,, Garrett & Dunner, L.L.P., 1300 I Street, N.W., Washington, DC, 20005-3315, US

(21) Appl. No.: 10/648,310

(22) Filed: Aug. 27, 2003

(30) Foreign Application Priority Data
Aug. 28, 2002 (JP) 2002-249200

(51) Int. Cl. G09G 5/00

(52) U.S. Cl. 345/173

(57) ABSTRACT

An electronic apparatus includes a touch pad and a mode switching section that switches between i) a first operation mode in which a pointer on a display screen is moved according to a distance and a direction that a contact point on the touch pad moves and ii) a second operation mode in which the pointer on the display screen is moved with a vector corresponding to a distance and a direction from a reference point provided on the touch pad to the contact point.

### CROSS-REFERENCE TO RELATED APPLICATIONS

This application is based upon and claims the benefit of priority from prior Japanese Patent Application No. 2002-249200, filed Aug. 28, 2002, the entire contents of which are incorporated herein by reference.

### BACKGROUND OF THE INVENTION

1. Field of the Invention

The present invention relates to an electronic apparatus capable of controlling the movement of a pointer on the screen of a display unit in response to an input operation on a touch pad device and to an operation mode switching method.

2. Description of the Related Art

Many electronic devices, such as notebook computers (PCs), are provided with a touch pad device, a kind of pointing device. A touch pad device enables the user to move a pointer (or graphic cursor) on the screen of the display unit to the desired position and click or drag the pointer even without a mouse. Thus, the touch pad device is particularly useful when the space where the electronic apparatus is placed is small or when the user carries the electronic apparatus with him or her.

With the touch pad device, the user is forced to operate the pointer on the pad face, or a limited face, as compared with a mouse. Therefore, for instance, when the user wants to move the pointer greatly within the screen, he or she often has to rub the touch pad with a fingertip more than once.

To make the act of rubbing the touch pad necessary only once, the amount of movement of the pointer (or the degree of movement of the pointer on the screen with respect to the movement of the contact point on the touch pad) may be set larger. In this case, it is difficult to control the movement of the pointer minutely. On the other hand, to make it easier to operate the pointer minutely, the amount of movement of the pointer may be set smaller. In this case, one disadvantage is that the act of rubbing the touch pad has to be repeated more than once as described above.

One of the techniques for solving such a problem has been disclosed in Jpn. Pat. Appln. KOKAI Publication No. 2001-282450. This reference has disclosed a pointing device where a specific position on the pad face is defined as the origin of the coordinates, the speed of a pointer when the position pointing means (such as a finger or a rod) points at the origin of the pad face is defined as 0, and the two-dimensional coordinates on the pad face pointed at by the position pointing means are defined as a speed vector value of the pointer. In this method, the direction of movement of and the moving speed of the pointer can be controlled by simply stopping the position control means, such as a finger, on the pad and moving its position slightly.

Users accustomed to the method described in the reference feel the method to be easy to use. However, users unaccustomed to the method may feel the usual method to be easier to use. In addition, even when users are accustomed to the method, they may feel the usual method to be easier to use, depending on the type of application program used on the screen.

Furthermore, it may be more convenient to execute the pointer moving process, the screen panning process, and the like by use of a touch pad device. In the prior art, however, use of a touch pad device to execute such processes could not be realized easily.

### BRIEF SUMMARY OF THE INVENTION

Embodiments of the present invention may provide an electronic apparatus capable of providing a plurality of input modes with a touch pad and an operation mode switching method.

According to one aspect of the present invention, there is provided an electronic apparatus, comprising a touch pad, and a mode switching section that switches between i) a first operation mode in which a pointer on a display screen is moved according to a distance and a direction that a contact point on the touch pad moves and ii) a second operation mode in which the pointer on the display screen is moved with a vector according to a distance and a direction from a reference point provided on the touch pad to the contact point.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a front view of a computer according to an embodiment of the present invention, with its display unit opened;

FIG. 2 is a block diagram of the computer;

FIG. 3 schematically shows the configuration related to the flow of processing from the touch pad device to the display screen;

FIGS. 4A, 4B, and 4C show the movement of the contact point on the touch pad and the movement of a pointer on the display screen in “Basic Mode”;

FIGS. 5A, 5B, and 5C show the movement of the contact point on the touch pad and the movement of the pointer on the display screen in “Speed Vector Mode”;

FIGS. 6A and 6B show the movement of the contact point on the touch pad and the movement of an actual screen within a virtual screen in “Panning Mode”; and

FIG. 7 shows a method of switching between three operation modes.

### DETAILED DESCRIPTION OF THE INVENTION

Embodiments of the present invention will be described below with reference to the drawings.

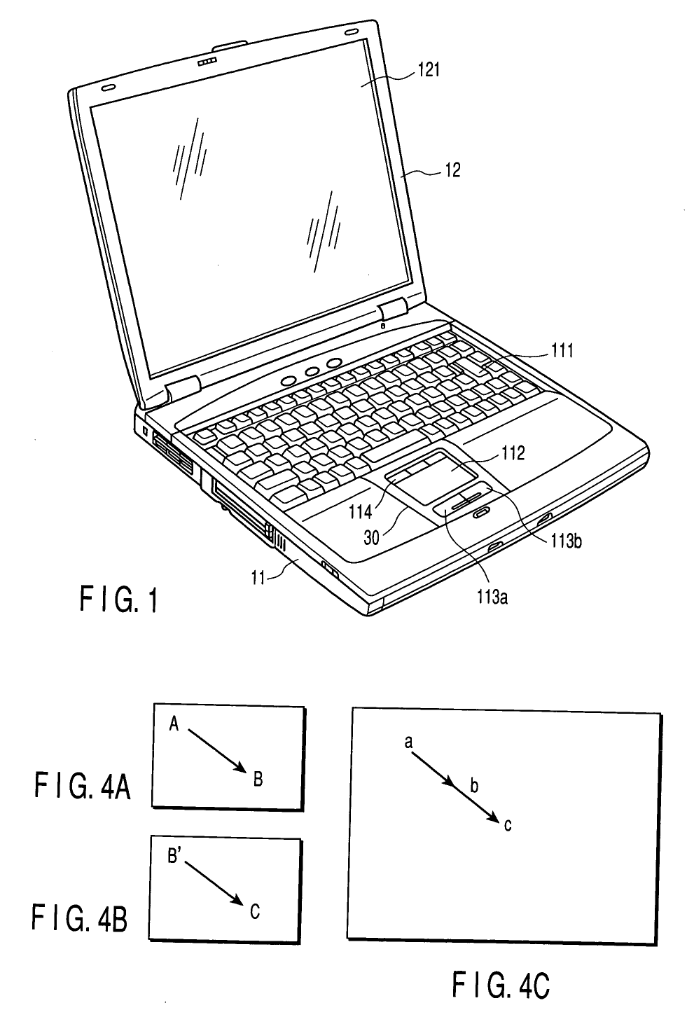

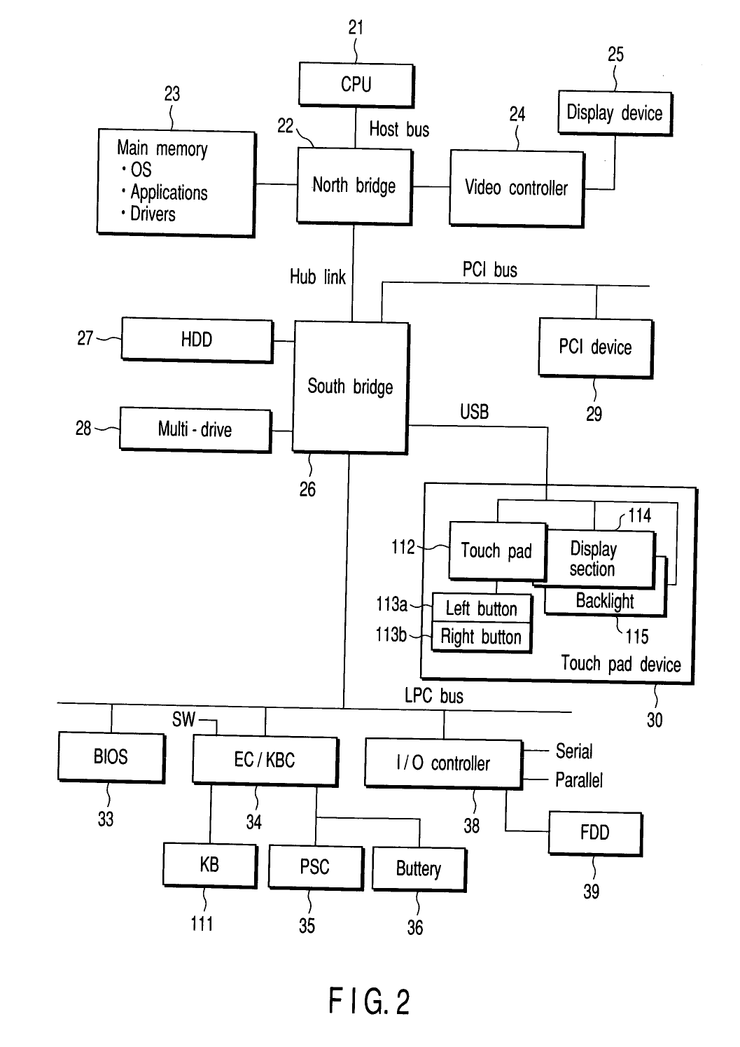

The configuration of an electronic apparatus according to an embodiment of the present invention will be explained by reference to FIGS. 1 and 2. The electronic apparatus is, e.g., a notebook personal computer.

FIG. 1 is a front view of the computer, with its display unit opened.

The computer includes a computer body 11 and a display unit 12. A display device as a liquid crystal display (LCD) is incorporated into the display unit 12. The display screen 121 of the LCD is almost in the center of the display unit 12. The display unit 12 is pivotally provided on the computer body 11 so that that it can move between an open position and a closed position.

The computer body 11 has a thin box-like housing. On the top face of the housing, a keyboard 111 is provided. An armrest is formed on the top face of the housing in front of the keyboard 111. Almost in the central part of the armrest, a touch pad device 30, a pointing device integral with a display, is provided. The touch pad device 30 includes a touch pad 112, a left button 113a, a right button 113b, and a display section (LCD) 114.

FIG. 2 is a block diagram showing a configuration of the computer. The elements corresponding to those in FIG. 1 are indicated by the same reference numerals.

The computer includes a central processing unit (CPU) 21, a north bridge 22, a main memory 23, a video controller 24, a display device 25, a south bridge 26, a hard disk drive (HDD) 27, a multi-drive 28, a peripheral component interconnect (PCI) device 29, a touch pad device 30, a basic input/output system ROM (BIOS-ROM) 33, an embedded controller/keyboard controller (EC/KBC) 34, a power supply controller (PSC) 35, a battery 36, an I/O controller 38, an FDD 39, and a keyboard (KB) 111.

The CPU 21, which supervises control of the whole information terminal, uses the main memory 23 as a work area and executes various programs.

The north bridge 22 includes various controllers for performing a bridging process between the CPU 21 and the south bridge 26, control of the main memory 23, control of the video controller 24, and the like.

The main memory 23, which holds an operating system (OS) processed by the CPU 21, various applications, various drivers, and others, is provided as a work area for the CPU 21. The various drivers include a touch pad driver and a display driver, which will be explained later.

The video controller 24, which is connected to the north bridge 22 via an accelerated graphics port (AGP), controls the data to be displayed on the LCD 25 (or an CRT externally connected).

The display device 25, which is incorporated into the display unit 12, displays the data sent from the video controller 24 on the screen of the LCD.

The south bridge 26, which is connected to the north bridge 22 via a hub link, includes various controllers for controlling various devices on a low pin count (LPC) bus, various PCI devices on a PCI bus, disk drives compatible with integrated drive electronics (IDE), and universal serial bus (USB) devices.

The HDD 27, which is connected as a device compatible with the primary IDE to the south bridge 26, drives a built-in hard disk that stores an OS and various programs.

The multi-driver 28, which is connected as a device compatible with the secondary IDE to the south bride 26, drives a removable recording medium, such as a CD-ROM, a DVD-ROM, or a CD-R/RW.

The touch pad device 30, which is connected as a device complying with USB to the south bride 26, includes not only the touch pad 112, left button 113a, right button 113b, and display section (LCD) 114 but also a backlight 115 for illuminating the display section 114.

The BIOS-ROM 33, which is connected to the LPC bus, stores a BIOS that mainly executes the process of setting the hardware of the information terminal when the power supply is turned on.

The EC/KBC 34, which is connected to the LPC bus, controls the power supply controller 35 and an input device, such as the keyboard 111. The EC/KBC 34 includes an embedded controller (EC), a built-in controller, integral with a keyboard controller.

The power supply controller 35, which is connected to the EC/KBC 34 via an I²C bus, controls the voltage supplied to each section of the information terminal.

The battery 36 is used as a power supply that supplies power to each section of the information terminal when there is no external power supply during the movement of the information terminal.

The I/O controller 38, which is connected to the LPC bus, controls not only the input and output of a serial signal or a parallel signal to and from the outside world but also the input and output to and from the FDD 39.

The FDD 39, which is connected to the I/O controller 38, drives a removable magnetic recording medium (or disk).

The keyboard 111, which is connected to the EC/KBC 34, informs the KBC of the corresponding input signal when various keys are pressed.

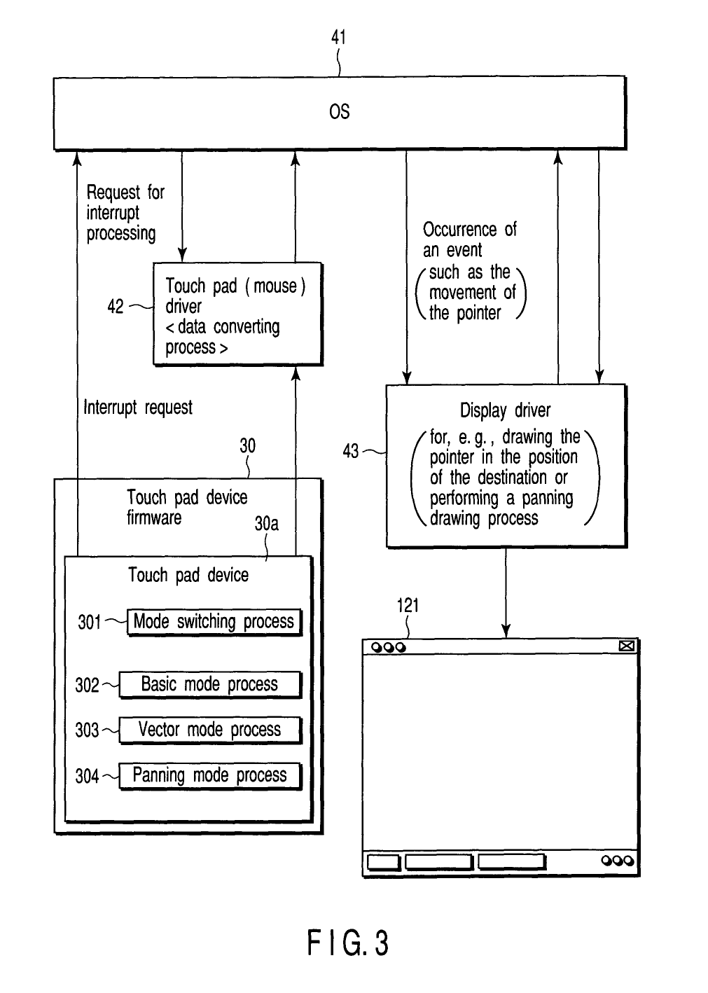

FIG. 3 schematically shows the configuration related to the flow of processing from the touch pad device 30 to the display screen 121. The elements common to those in FIGS. 1 and 2 are indicated by the same reference numerals.

Under the control of the OS 41, the touch pad driver 42 and the display driver 43 are operating.

The touch pad driver 42 is a software driver provided so as to correspond to the touch pad device 30. Based on the information (position information representing the contact point (on the pad face) on the touch pad 112 or various types of control information) outputted from the touch pad device 30, the touch pad driver 42 controls the movement of the pointer or the like on the display screen 121 via the OS 41 and display driver 43.

The firmware 30a for the touch pad device 30 in the embodiment includes a mode switching section 301 which performs switching control of operation modes between “Basic Mode,” “Speed Vector Mode,” and “Panning Mode” according to a specific input operation on the touch pad device 30.

“Basic Mode” is an operation mode in which the pointer on the display screen 121 is moved according to the distance and direction that the contact point on the touch pad 112 moves.

“Speed Vector mode” is an operation mode in which the pointer on the display screen 121 is moved with a vector (speed vector) according to the distance and direction from a reference point provided on the touch pad 112 to the contact point.

“Panning mode” is an operation mode in which the actual screen on the display screen is moved within a virtual screen existing beyond the range of the display screen according to the distance and direction that the contact point on the touch pad 112 moves.

The three operation modes are realized by a basic mode processing section 302, a speed vector mode processing section 303, and a panning mode processing section 304.

In the display section 114 (see FIG. 1) of the touch pad device 30, there is particularly provided an area where an LCD displays which one of “Basic mode,” “Speed Vector Mode,” and “Panning Mode” has been selected and set. In this case, operation mode names may be displayed on the LCD.

The firmware 30a in the touch pad device 30 senses the switching of the operation mode (or the specification of the operation mode) according to the input operation by use of, for example, at least one of the left button 113a and the right button 113b, displays on the display section 114 a message that the corresponding operation mode has been specified, makes an interrupt request to the OS 41, and at the same time, sends the control information (or position information) corresponding to the specified operation mode to the touch pad driver 42.

The firmware 30a may be designed as follows. When any one of the areas of the display section 114 is touched with a finger or the like, the firmware 30a senses the position of the contact point, identifies the operation mode corresponding to the sensed position, displays on the display section 114 a message that the operation mode has been specified, makes an interrupt request to the OS 41, and at the same time, sends the control information (or position information) corresponding to the specified operation mode to the touch pad driver 42.

The touch pad (mouse) driver 42, which responds to the interrupt request from the OS 42, converts the control signal (or the corresponding position information) sent from the firmware 30a of the touch pad device to data usable in the OS 41.

On the other hand, the display driver 43, when responding to an event broadcast from the OS 41, acquires control information from the touch pad driver 42, and controls the display of the pointer on the display screen 121 (e.g., the drawing of the pointer in the position of the destination or a panning and drawing process) according to the control information.

The flow of the whole processing in the configuration of FIG. 3 will be explained later.

The details of the three operation modes will be explained by reference to FIGS. 4A, 4B, 4C, 5A, 5B, 5C, 6A and 6B.

FIGS. 4A, 4B, and 4C show the movement of the contact point on the touch pad 112 and the movement of the pointer on the display screen in “Basic Mode.”

“Basic Mode” is an operation mode in which the pointer on the display screen is moved according to the distance and direction that the contact point on the touch pad 112 moves.

For instance, in a state where the pointer on the display screen is in position a as shown in FIG. 4C, when the user moves the contact point on the touch pad 112 from position A to position B as shown in FIG. 4A, the pointer moves from position a to position b according to the distance and direction of the movement as shown in FIG. 4C. In this case, the amount of movement of the pointer is proportional to the distance the contact point moves.

Next, when the user moves the contact point on the touch pad 112 from position B′ to position C as shown in FIG. 4B, the pointer on the display screen moves from position b to position c according to the distance and direction of the movement as shown in FIG. 4C.

As described above, when moving the pointer greatly in the basic mode, the user often has to move the contact point more than once. Because many users are accustomed to using the basic mode, the basic mode can be said to be an operation mode the user can use safely.

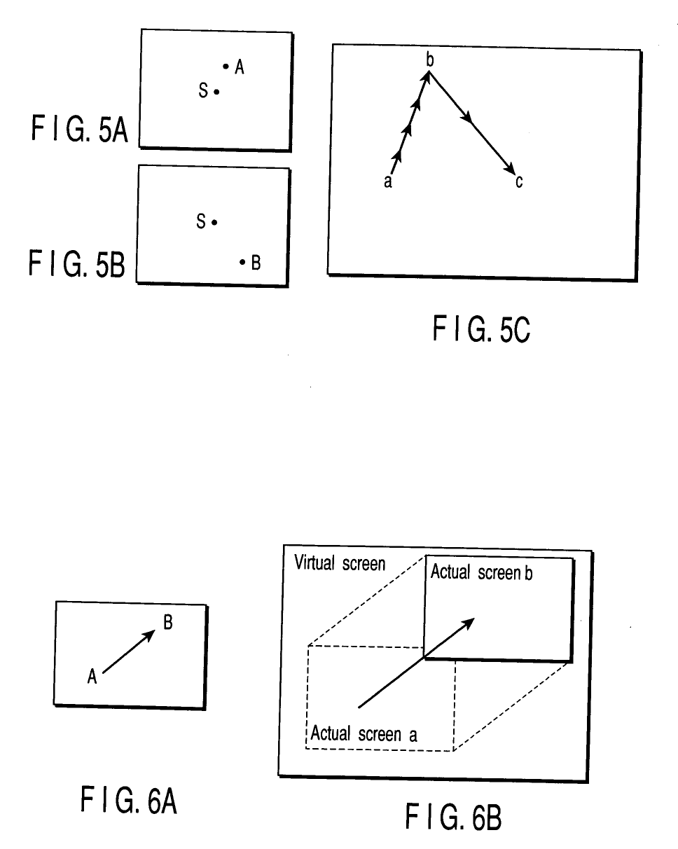

FIGS. 5A, 5B, and 5C show the movement of the contact point on the touch pad 112 and the movement of the pointer on the screen in “Speed Vector Mode.”

As described earlier, “Speed Vector Mode” is a mode in which the pointer on the screen is moved with a vector (speed vector) corresponding to the distance and direction from a reference point provided on the touch pad 112 to the contact point. That is, control is performed in such a manner that, the larger the distance from the reference point on the touch pad 12 to the contact point becomes, the greater the moving speed of the pointer on the screen becomes.

For instance, in a state where the pointer on the display screen is in position a as shown in FIG. 5C, when the user touches the contact point on the touch pad 112 at point A slightly separate from the central point (reference point) on the touch pad 112 with a finger or the like as shown in FIG. 5A, and keeps the contact state for a specific time, the pointer moves from point a to point b at a speed corresponding to the distance from the central point S to point A as shown in FIG. 5C. That is, while the contact state is being kept, the pointer continues moving. When the contact state is stopped (or the contact point is positioned at the central point S), the pointer stops. The number of arrows in FIG. 5C indicates the number of unit times.

Next, when the user touches the contact point on the touch pad 112 at point B quite separate from the central point (reference point) S on the touch pad 112 with a finger or the like as shown in FIG. 5B, and keeps the contact state for a specific time, the pointer moves from point b to point c at a speed corresponding to the distance from the central point S to point B as shown in FIG. 5C.

The moving speed of the pointer may be set so as to be proportional to the distance from the central point S on the touch pad 112 to the contact point or so as to have a value weighted suitably according to the distance. For instance, the moving speed of the pointer may be set so as to be much higher as follows: the larger the distance from the central point S to the contact point becomes, the greater the weight added to the distance is made. Parameters, including the weight coefficient related to the weighting, may be set or changed by the user by means of utility or application programs.

In the speed vector mode, it is possible to perform not only large movement control of the pointer easily with a small manipulated variable but also minute movement control of the pointer easily, which enables an operation similar to the operation of an acupoint to be realized.

FIGS. 6A and 6B show the movement of the contact point on the touch pad 112 and the movement of the actual screen within a virtual screen in “Panning Mode.”

“Panning mode” is a mode in which the actual screen on the display screen is moved within a virtual screen existing beyond the range of the display screen according to the distance and direction that the contact point on the touch pad 112 moves. In the operation modes excluding the panning mode, when the pointer exists on the actual screen and further instructed to move outside the actual screen, the firmware 30a controls the actual screen so as not to move within the virtual screen.

For instance, in a state where the actual image on the display screen is in position a as shown in FIG. 6B, when the user moves the contact point on the touch pad 112 from point A to point B as shown in FIG. 6A, the actual image moves from position a to position b according to the distance and direction of the movement as shown in FIG. 6B. In this case, the amount of movement of the actual image is proportional to the distance the contact point moves.

Generally, in a low-resolution display device, such as an LCD screen, a virtual screen can be used effectively. To move the actual screen within the virtual screen, it is normally necessary to move the pointer greatly to the end of the actual screen. That is, to check items in the virtual screen excluding the actual screen, it is generally necessary to move the pointer greatly. To overcome this drawback, the panning mode in the embodiment enables only the actual screen to pan according to the movement of the contact point on the touch pad without moving the pointer to move the actual screen. As a result, the user need not operate to move the pointer on the display screen and can move only the actual screen by just rubbing the touch pad.

Furthermore, the user might move the actual screen by mistake, when operating the pointer at the end of the screen for the purpose other than moving the actual screen. To overcome this mistake, the actual screen is fixed in the modes excluding the panning mode in the embodiment. That is, when the pointer is on the actual screen and further instructed to move outside the actual screen, the actual screen is stopped from moving. This prevents the screen from moving inadvertently, while the user is operating the pointer at the end of the screen.

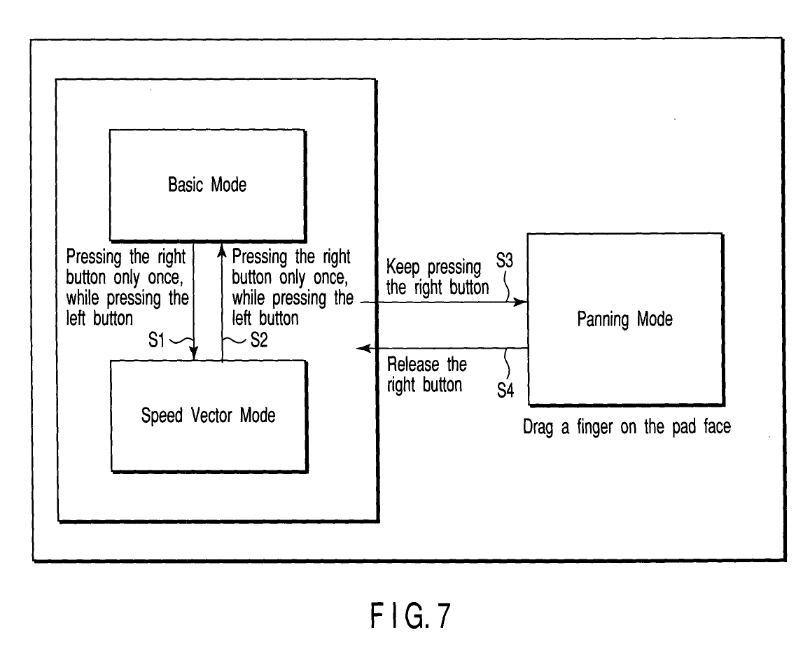

FIG. 7 shows a method of switching between the three operation modes.

The switching from “Basic Mode” to “Speed Vector Mode” is effected by pressing the right button once, while pressing the left button (step S1). On the other hand, the switching from “Speed Vector Mode” to “Basic Mode” is effected by pressing the right button once, while pressing the left button (step S2). That is, when the right button is pressed repeatedly, with the left button being pressed, “Basic Mode” and “Speed Vector Mode” are set alternately.

Furthermore, in a state where either “Basic Mode” or “Speed Vector Mode” has been set, when the right button is kept pressed, the mode changes to “Panning Mode” (step S3). To pan the actual screen, the user rubs the touch pad 112 with a finger or the like, while pressing the right button (that is, performs a drag operation). When the user releases the right button, the operation mode returns to the one set immediately before the panning (either “Basic Mode” or “Speed Vector Mode”) (step S4).

As described above, in the example of FIG. 7, the left button 113a and right button 113b located closest to the touch pad 112 are used as mode switching input keys. This makes it possible to execute both of the mode switching operation and the operation on the pad face quickly and accurately.

A specific key on the keyboard 111 may be used together with the left button 113a or the right button 113b, thereby switching the mode. Instead of using the left button 113a and right button 113b on the touch pad device, a specific key on the keyboard 111 may be used to switch the mode.

Referring to FIG. 3, the flow of the whole processing in a case where “Speed Vector Mode” has been selected will be explained.

When the user performs an input operation corresponding to “Speed Vector Mode” by using, for example, the left button 113a and right button 113b, the firmware 30a in the touch pad device 30, according to the operation, senses the switching to “Speed Vector Mode” (or the specification of “Speed Vector Mode”), and displays a message that “Speed Vector Mode” has been specified in the corresponding area (LCD) of the display section 114 (see FIG. 1).

Based on the mode switching signal (or position signal) sensed by the touch pad device 30, the mode switching section 301 in the firmware 30a switches the operation mode to “Speed Vector Mode.”

When the user touches the pad face with a fingertip or the like, the touch pad device 30 senses the position signal representing the contact position. Based on the position signal, the vector mode processing section 303 in the firmware 30 executes the processing corresponding to the speed vector mode.

When sensing a new position from the position signal, the vector mode processing section 303 recognizes that the touch pad 112 has been newly touched or the contact point has moved, finds the distance and direction from the reference point on the touch pad 112 to the contact point, and calculates the speed vector in moving the pointer on the display screen 121. At the same time, the firmware 30a interrupts the OS 41.

In the embodiment, the firmware 30a interrupts the OS 41 at regular intervals of time, while the touch pad 112 is being touched.

Receiving the interrupt, the OS 41 makes an interrupt process request to the touch pad driver 42 and passes control to the touch pad driver 42. As a result, the touch pad driver 42 converts the speed vector calculated at the vector mode processing section 303 into a form that can be processed by the OS 41. Then, the OS 41 broadcasts to various corresponding types of software as mouse events. At this time, the display driver 43 senses the event and requests the relevant control information from the OS 41. As a result, the touch pad driver 42 passes the control information including the speed vector to the display driver 43.

According to the control information, the device driver 43 performs display control to move the pointer on the display screen 121 with the speed vector specified in the control information.

While in the embodiment, the speed vector has been calculated at the touch pad driver 42, a similar process may be realized by trapping (or hooking) the mouse control function provided in the OS 41.

Furthermore, when the “Panning Mode” has been selected, the basic flow is similar to that of the above operation. In this case, too, a similar process may be realized by trapping (or hooking) the mouse control function provided in the OS 41.

With the above embodiment, it is possible to execute both of the mode switching operation and the operation on the pad face quickly and accurately.

While in the embodiment, the touch pad device has been a device complying with USB, it may be configured as an interface (such as PCI) other than USB.

In addition, while in the embodiment, the three operation modes have been selectively switched, only two of the three operation modes may be selectively switched.

Moreover, while in the embodiment, a pointer has been used as an object to be moved on the screen of the display device, the present invention is not limited to this. For instance, a display window or a scroll bar on the screen may be used as an object to be moved. In this case, mode switching control between the normal operation mode and the vector mode enables the movement of the display window or the scroll bar on the screen to be changed. When scrolling is done, use of the vector mode makes it easer to scroll the screen.

As has been described in detail, with the present invention, it is possible to provide a plurality of input modes with a touch pad.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic apparatus, comprising:
a touch pad; and
a mode switching section that switches between i) a first operation mode in which a pointer on a display screen is moved according to a distance and a direction that a contact point on the touch pad moves and ii) a second operation mode in which the pointer on the display screen is moved with a vector according to a distance and a direction from a reference point provided on the touch pad to the contact point.

2. The electronic apparatus according to claim 1, further comprising a process section that changes a moving speed of the pointer on the display screen according to the distance from the reference point on the touch pad and the contact point in the second operation mode.

3. The electronic apparatus according to claim 1, wherein the mode switching section switches between the first operation mode and the second operation mode according to a specific operation on click buttons provided on the touch pad device.

4. The electronic apparatus according to claim 1, wherein the mode switching section switches between the first operation mode and the second operation mode in response to contact with a specific area provided for each of the operation modes as a part of the touch pad.

5. An electronic apparatus, comprising:
a touch pad; and
a mode switching section that switches between i) a first operation mode in which a pointer on a display screen is moved according to a distance and a direction that a contact point on the touch pad moves and ii) a second operation mode in which an actual screen on the display screen is moved within a virtual screen existing beyond a range of the display screen according to a distance and a direction that the contact point on the touch pad moves.

6. The electronic apparatus according to claim 5, further comprising a control section which performs control to prevent the actual screen from moving within the virtual screen, when the pointer is on the actual screen and further instructed to move outside the actual screen in an operation mode other than the second operation mode.

7. An electronic apparatus, comprising:
a touch pad; and
a mode switching section that switches between i) a first operation mode in which a pointer on a display screen is moved with a vector corresponding to a distance and a direction from a reference point provided on the touch pad to a contact point and ii) a second operation mode in which an actual screen on the display screen is moved within a virtual screen existing beyond a range of the display screen according to a distance and a direction that the contact point on the touch pad moves.

8. An electronic apparatus, comprising:
a touch pad; and
a mode switching section that switches between i) a first operation mode in which a pointer on a display screen is moved according to a distance and a direction that a contact point on the touch pad moves, ii) a second operation mode in which the pointer on the display screen is moved with a vector corresponding to a distance and a direction from a reference point provided on the touch pad to the contact point, and iii) a third operation mode in which an actual screen on the display screen is moved within a virtual screen existing beyond a range of the display screen according to a distance and a direction that the contact point on the touch pad moves.

9. The electronic apparatus according to claim 8, wherein the mode switching section switches between the first operation mode, the second operation mode, and the third operation mode according to a specific operation on click buttons provided on the touch pad device.

10. The electronic apparatus according to claim 8, wherein the mode switching section switches between the first operation mode, the second operation mode, and the third operation mode in response to contact with a specific area provided for each of the operation modes as a part of the touch pad.

11. An operation mode switching method for an electronic apparatus capable of controlling an operation of an object displayed on a display screen based on a position signal representing a contact point on a touch pad outputted from the touch pad, the method comprising:
enabling one of i) a first operation mode in which the object on the display screen is moved according to a distance and a direction that the contact point on the touch pad moves and ii) a second operation mode in which the object on the display screen is moved with a speed vector corresponding to a distance and a direction from a reference point provided on the touch pad to the contact point; and
enabling switching between the first operation mode and the second operation mode.

12. The operation mode switching method according to claim 11, further comprising changing a moving speed of the object on the display screen according to the distance from the reference point on the touch pad to the contact point in the second operation mode.

13. The operation mode switching method according to claim 11, further comprising switching between the first operation mode and the second operation mode according to a specific operation on click buttons provided on the touch pad device.

14. The operation mode switching method according to claim 11, further comprising switching between the first operation mode and the second operation mode in response to contact with a specific area provided for each of the operation modes as a part of the touch pad.

15. An operation mode switching method for an electronic apparatus capable of controlling an operation of an object displayed on a display screen based on a position signal representing a contact point on a touch pad outputted from the touch pad, the method comprising:
enabling one of i) a first operation mode in which the object on the display screen is moved according to a distance and a direction that the contact point on the touch pad moves and ii) a second operation mode in which the object on the display screen is moved within a virtual screen existing beyond a range of the display screen according to a distance and a direction that the contact point on the touch pad moves; and
enabling switching between the first operation mode and the second operation mode.

16. The operation mode switching method according to claim 15, further comprising preventing the actual screen from moving within the virtual screen, when the pointer is on the actual screen and further instructed to move outside the actual screen in an operation mode other than the second operation mode.

17. An operation mode switching method for an electronic apparatus capable of controlling an operation of an object displayed on a display screen based on a position signal representing a contact point on a touch pad outputted from the touch pad, the method comprising:
enabling i) a first operation mode in which the object on the display screen is moved with a speed vector corresponding to the distance from a reference point provided on the touch pad to the contact point and ii) a second operation mode in which the object on the display screen is moved within a virtual screen existing beyond a range of the display screen according to a distance and a direction that the contact point on the touch pad moves; and
enabling switching between the first operation mode and the second operation mode.

18. An operation mode switching method for an electronic apparatus capable of controlling an operation of an object displayed on a display screen based on a position signal representing a contact point on a touch pad outputted from the touch pad, the method comprising:
enabling one of i) a first operation mode in which the object on the display screen is moved according to a distance and a direction that the contact point on the touch pad moves, ii) a second operation mode in which the object on the display screen is moved with a vector corresponding to a distance and a direction from a reference point provided on the touch pad to the contact point, and iii) a third operation mode in which the object on the display screen is moved within a virtual screen existing beyond a range of the display screen according to a distance and a direction that the contact point on the touch pad moves; and
enabling switching between the first operation mode, the second operation mode, and the third operation mode.

19. The operation mode switching method according to claim 18, further comprising switching between the first operation mode, the second operation mode, and the third operation mode according to a specific operation on click buttons provided on the touch pad device.

20. The operation mode switching method according to claim 18, further comprising switching between the first operation mode, the second operation mode, and the third operation mode in response to contact with a specific area provided for each of the operation modes as a part of the touch pad.
